(19) United States
(12) Patent Application Publication
(10) Pub. No.: US 2016/0045049 A1
(43) Pub. Date: Feb. 18, 2016

(54) BEVERAGE COASTER FOR VISUALLY IMPAIRED PERSON

(71) Applicant: Solomon L. Kim, Palo Alto, CA (US)

(72) Inventor: Solomon L. Kim, Palo Alto, CA (US)

(21) Appl. No.: 14/457,364

(22) Filed: Aug. 12, 2014

(51) Int. Cl. A47G 23/03; G01G 23/14; G01G 23/18; G01G 19/52

(52) U.S. Cl. CPC A47G 23/0306; G01G 19/52; G01G 23/14; G01G 23/18; A47G 2200/14; A47G 2200/226

(57) ABSTRACT

A beverage coaster for a visually impaired person is provided. The beverage coaster for a visually impaired person includes a beverage coaster upper portion, a beverage coaster lower portion disposed to be spaced apart from the beverage coaster upper portion, an elastic member disposed between the beverage coaster upper portion and the beverage coaster lower portion to form an interval therebetween, a weight detecting unit detecting a weight of an object placed on the beverage coaster upper portion, and an audio unit outputting a sound in the case that a predetermined level of weight is detected by the weight detecting unit.

### BACKGROUND

The present disclosure relates to a beverage coaster for a visually impaired person, and more particularly, to a beverage coaster capable of generating a sound in the case that a drinking vessel placed thereon is filled with a predetermined amount of beverage, so as to prevent beverage from overflowing from the drinking vessel.

In the case of visually impaired persons, since such people cannot easily identify an amount of beverage within a drinking vessel while pouring a beverage into the drinking vessel in order to drink from the drinking vessel, there may be inconvenience in that beverage may overflow from the drinking vessel.

As commercially available drinking vessels for visually impaired persons to reduce the inconvenience, several products have been provided, but the volumes of the drinking vessels for visually impaired persons according to the related art are relatively large and the portability thereof may thus be deteriorated, such that there is inconvenience in that the drinking vessels may not be constantly used in a person's day-to-day life.

In addition, like the disclosure of Korean Utility Model Application No. 1984-0000037, in the case of a saucer for a drinking vessel or the like, in which in the case that a drinking vessel is placed thereon, a sound is generated, the sound output is initiated using a light sensor. In this case, the light sensor may not be smoothly operated, depending on a surrounding light environment, such that there may be inconvenience in the use thereof.

Accordingly, in the case of a conveniently portable beverage coaster for a visually impaired person, capable of definitely providing information related to a state of a drinking vessel via a sound in the case that a predetermined amount of beverage is poured into the drinking vessel, it may be expected that such a beverage coaster may be usefully used in the related technical area.

### SUMMARY

Some embodiments of the present disclosure may provide a beverage coaster for a visually impaired person, capable of outputting a sound in the case that a predetermined weight thereof is detected, and preventing slippage of a cup, so as to allow a visually impaired person to conveniently use the drinking vessel.

According to some embodiments of the present disclosure, a beverage coaster for a visually impaired person may include: a beverage coaster upper portion; a beverage coaster lower portion disposed to be spaced apart from the beverage coaster upper portion; an elastic member disposed between the beverage coaster upper portion and the beverage coaster lower portion to form an interval therebetween; a weight detecting unit detecting a weight of an object placed on the beverage coaster upper portion; and an audio unit outputting a sound in the case that a predetermined level of weight is detected by the weight detecting unit.

The weight detecting unit may be a load cell or a piezoelectric element.

In the case that the weight detecting unit is the load cell, the audio unit may include a load cell initializing portion for zeroing the load cell.

The beverage coaster upper portion may include an initialization button connected to the load cell initializing portion.

The sound may be an alarm sound or a melody sound.

The elastic member may be a spring.

A surface of the beverage coaster upper portion may include an embossing or a concave-convex ( [symbol] ) portion.

A material of the beverage coaster upper portion may contain one or more selected from a group consisting of nitrile rubber, natural rubber, acrylic rubber, urethane rubber, fluorinated rubber, silicon rubber, an epoxy-based resin, a polyimide resin, a polyamide resin, a phenol-based resin, and a melamine-based resin.

The weight detecting unit may be set to detect a value of a weight selected from within a range of 150 g to 400 g.

The surface of the beverage coaster upper portion may further include an edge protrusion having a height of 0.5 cm to 2 cm.

The beverage coaster for a visually impaired person may further include a sealing portion sealing edges of the beverage coaster upper portion and the beverage coaster lower portion.

### BRIEF DESCRIPTION OF DRAWINGS

The above and other aspects, features and other advantages of the present disclosure will be more clearly understood from the following detailed description taken in conjunction with the accompanying drawings, in which:

FIGS. 1a and 1b are respectively a cross-sectional view and a perspective view of a beverage coaster according to an exemplary embodiment of the present disclosure by way of example;

FIGS. 2a and 2b illustrate the forms of beverage coaster upper portions according to an exemplary embodiment of the present disclosure by way of examples;

FIG. 3 illustrates an example of a process of manufacturing a beverage coaster for a visually impaired person according to an exemplary embodiment of the present disclosure; and

FIG. 4 illustrates another example of a process of manufacturing a beverage coaster for a visually impaired person according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

According to an exemplary embodiment of the present disclosure, a beverage coaster, which is conveniently portable and provided such that a visually impaired person may avoid the inconvenience of a beverage overflowing from a drinking vessel while pouring the beverage into the drinking vessel, may be provided.

In detail, a beverage coaster for a visually impaired person according to an exemplary embodiment of the present disclosure may include a beverage coaster upper portion, a beverage coaster lower portion disposed to be spaced apart from the beverage coaster upper portion, an elastic member disposed between the beverage coaster upper portion and the beverage coaster lower portion to form an interval therebetween, a weight detecting unit detecting a weight of an object placed on the beverage coaster upper portion, and an audio unit outputting a sound in the case that a predetermined level of weight is detected by the weight detecting unit.

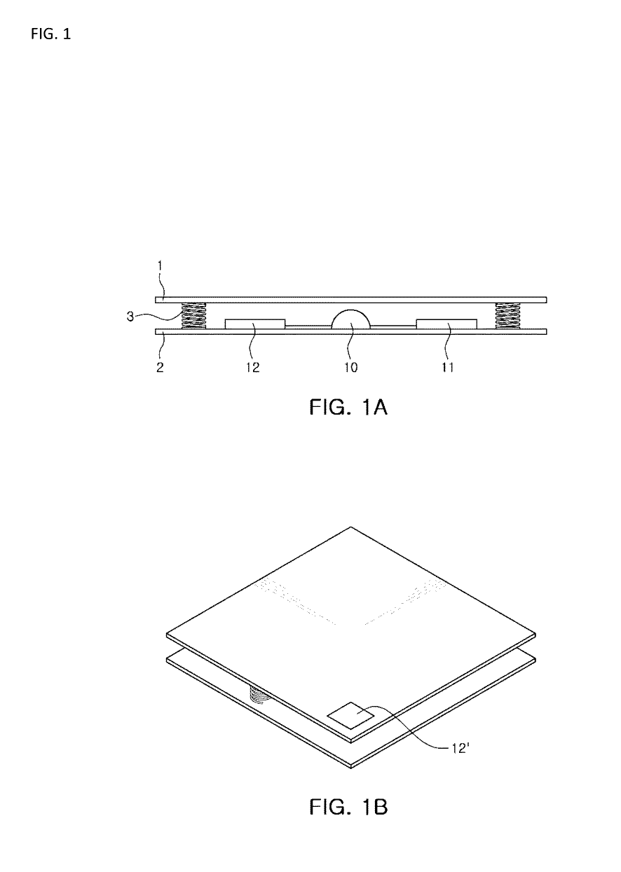

With reference to FIG. 1, the beverage coaster according to an exemplary embodiment of the present disclosure may include a beverage coaster upper portion 1, a beverage coaster lower portion 2 disposed to be spaced apart from the beverage coaster upper portion 1, and an elastic member 3 disposed between the beverage coaster upper portion 1 and the beverage coaster lower portion 2 to form a space, an interval, therebetween.

The elastic member 3 may form an interval between the beverage coaster upper portion 1 and the beverage coaster lower portion 2. In the case that a drinking vessel is placed on the beverage coaster upper portion 1, a height of the beverage coaster may be reduced such that the beverage coaster upper portion 1 contacts the weight detecting portion 10.

In the case that the beverage coaster upper portion 1 contacts the weight detecting portion 10 and a predetermined level of weight is then applied to the beverage coaster upper portion 1, the weight detecting portion 10 disposed between the beverage coaster upper portion 1 and the beverage coaster lower portion 2 detects a weight of an object placed on the beverage coaster upper portion 1. In addition, in the case that a predetermined level of the weight is detected by the weight detecting unit 10, a sound may be output by an audio unit 11 that outputs a sound in a case in which a predetermined level of weight is detected.

In the case of the beverage coaster for a visually impaired person according to an exemplary embodiment of the present disclosure, the weight detecting unit 10 may be a load cell or a piezoelectric element, and in detail, may be a load cell. On the other hand, the weight detecting unit 10 may include a microprocessor outputting a sound in a case in which a predetermined level of weight is detected thereby.

In a case in which the weight detecting unit 10 is a load cell, the audio unit 11 may further include a load cell initializing portion 12 for zeroing the load cell. Since a weight measured by the weight detecting unit 10 is a total weight obtained by adding weights of a beverage and a drinking vessel to each other, the total weight may be changed depending on a weight of the drinking vessel. Therefore, by including the load cell initializing portion 12 therein, in the case that first placing the drinking vessel on the beverage coaster, zeroing the load cell by using the load cell initializing portion 12, and then, pouring a beverage into the drinking vessel, only a weight of the beverage may be measured.

In this case, the beverage coaster upper portion 1 of the present disclosure may further include an initialization button 12′ connected to the load cell initializing portion 12 as illustrated in FIG. 1B. On the other hand, although the form of the initialization button 12′ is not particularly limited, the initialization button 12′ may be employed so as not to protrude from a beverage coaster upper portion surface, such that a bottom surface of the drinking vessel may not be inclined in the case that the drinking vessel is placed on the beverage coaster.

A sound output by the beverage coaster for a visually impaired person according to an exemplary embodiment of the present disclosure is not particularly limited. For example, the sound may be, for example, an alarm sound or a melody sound. In this case, a melody type is not particularly limited.

Furthermore, such an output sound may be accompanied by vibrations such that a more exact signal may be transferred to and sensed by a user.

On the other hand, a material of the elastic member 3 disposed between the beverage coaster upper portion 1 and the beverage coaster lower portion 2 to form an interval therebetween is not particularly limited in the beverage coaster according to the exemplary embodiment of the present disclosure. For example, the elastic member 3 may be configured using a spring, rubber, or the like. As a material of the elastic member 3, a material having a sufficient level of elasticity and restoring force may be used, which may satisfy conditions in which in the case that an object is placed on the beverage coaster upper portion 1, the beverage coaster upper portion 1 may freely descend while reducing a height of the beverage coaster, such that the beverage coaster upper portion 1 contacts the weight detecting unit 10, and then, in the case that a user drinks or the drinking vessel is removed, elasticity of the elastic member 3 may restore the beverage coaster upper portion 1 to an initial position thereof such that an interval between the beverage coaster upper portion 1 and the beverage coaster lower portion 2 may be maintained. For example, the elastic member 3 may be configured using a spring as illustrated in FIG. 1.

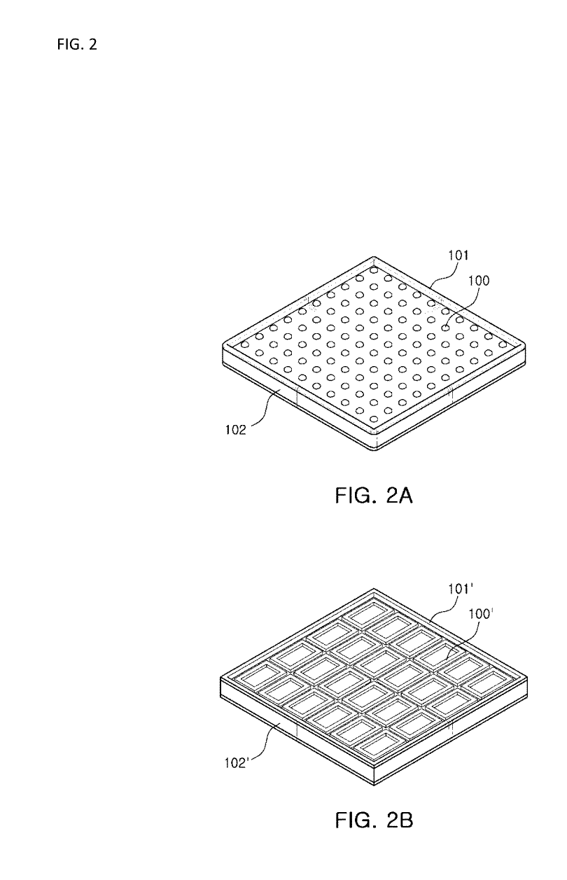

In addition, a surface of the beverage coaster upper portion 1 according to an exemplary embodiment of the present disclosure may be embossing or concave-convex ( [symbol] ) processed so as to prevent a slippage phenomenon at an interface between a bottom of the drinking vessel and a beverage coaster upper surface. FIGS. 2A and 2B illustrate an embossing 100 and a concave-convex portion 100′ on a surface of the beverage coaster upper portion 1 by way of example.

The embossings or the concave-convex portions ( [symbol] ) may be uniformly distributed as illustrated in FIGS. 2A and 2B or may have a specific form for a good-looking appearance, but are not limited thereto.

A height of embossings or concave-convex portions may be in a range of 0.01 to 0.5 cm. In the case that the height of the embossings or the concave-convex portions is less than 0.01 cm, a slippage prevention effect at the interface between the bottom of the drinking vessel and the beverage coaster upper portion may not be sufficient. Further, in the case that the height of the embossing or the concave-convex portion exceeds 0.05 cm, while the slippage prevention effect at the interface between the bottom of the drinking vessel and the beverage coaster upper portion may not be significantly increased, material may be unnecessarily consumed, and in a case in which foreign matter is caught between the concave-convex portions, it may be difficult to clean.

On the other hand, the embossings or the concave-convex portions may be formed on the beverage coaster upper surface integrally with the beverage coaster supper surface, or formed by further stacking a coating layer for the formation of embossings or concave-convex portions on the beverage coaster upper portion.

In the case of the beverage coaster for a visually impaired person according to an exemplary embodiment of the present disclosure, although materials of the beverage coaster upper portion 1 and the beverage coaster lower portion 2 may be the same as each other, in terms of slippage prevention, the material of the upper coaster upper portion may contain one or more selected from a group consisting of nitrile rubber, natural rubber, acrylic rubber, urethane rubber, fluorinated rubber, silicon rubber, an epoxy-based resin, a polyimide resin, a polyamide resin, a phenol-based resin, and a melamine-based resin.

In the case that the beverage coaster upper portion has such a form and material, the slippage prevention effects may be significantly increased.

On the other hand, in the case of the beverage coaster according to an exemplary embodiment of the present disclosure, the weight detecting unit 10 may be set to be able to detect a value of a weight selected from within a range of 150 g to 400 g. In a case in which the weight detecting unit 10 is set to detect a weight below 150 g, an amount of a beverage poured into a drinking vessel may not be sufficient for a single serving, and in a case in which the weight detecting unit 10 is set to detect a weight more than 400 g, an amount of a beverage poured into the drinking vessel may be excessive for a single serving.

However, such a weight range is only provided in consideration of a weight of a beverage in the case of further including a load cell initializing portion for zeroing a load cell. In the case of not including the load cell initializing portion, the weight detecting unit 10 may be set to be able to detect a weight corresponding to a value obtained by adding a weight of a drinking vessel, for example, about 150 g to 500 g, to the range of 150 g to 400 g.

In addition, in order to allow the drinking vessel to be propped stably on the beverage coaster upper portion, the beverage coaster upper portion of the present disclosure may be provided with an edge protrusion formed to have a height of 0.5 cm to 2 cm. FIGS. 2A and 2B illustrate edge protrusions 101 and 101′ by way of example.

Although the form of the protrusion is not particularly limited, a height of the protrusion may be higher than those of the embossings or the concave-convex portions. By forming such an edge protrusion, the drinking vessel may be prevented from slippage and being dropped from the beverage coaster so as be stably use the drinking vessel.

On the other hand, in order to improve durability of the beverage coaster and protect internal constituent elements thereof, the beverage coaster for a visually impaired person according to an exemplary embodiment of the present disclosure may further include a sealing portion 102 or 102′ sealing edges of the beverage coaster upper portion 1 and the beverage coaster lower portion 2 as illustrated in FIGS. 2A and 2B.

A material of the sealing portion is not particularly limited. As the material of the sealing portion, a material having elasticity such that it may be stretched depending on a change in an interval between the beverage coaster upper portion and the beverage coaster lower portion may be used. For example, rubber, vinyl, silicon, a soft polymer resin, or the like, may be used. Alternatively, a material such as fabric, of which the form may be changed to correspond to a change in an interval between the beverage coaster upper portion and the beverage coaster lower portion may be used. In addition, any material capable of accepting a change in an interval therebetween may also be used.

The present disclosure will be described in further detail through detailed exemplary embodiments. The following exemplary embodiments of the present disclosure are just provided as examples in order to assist in the understanding of the present disclosure and the scope of the present disclosure is not limited thereto.

### EMBODIMENT

### Embodiment 1

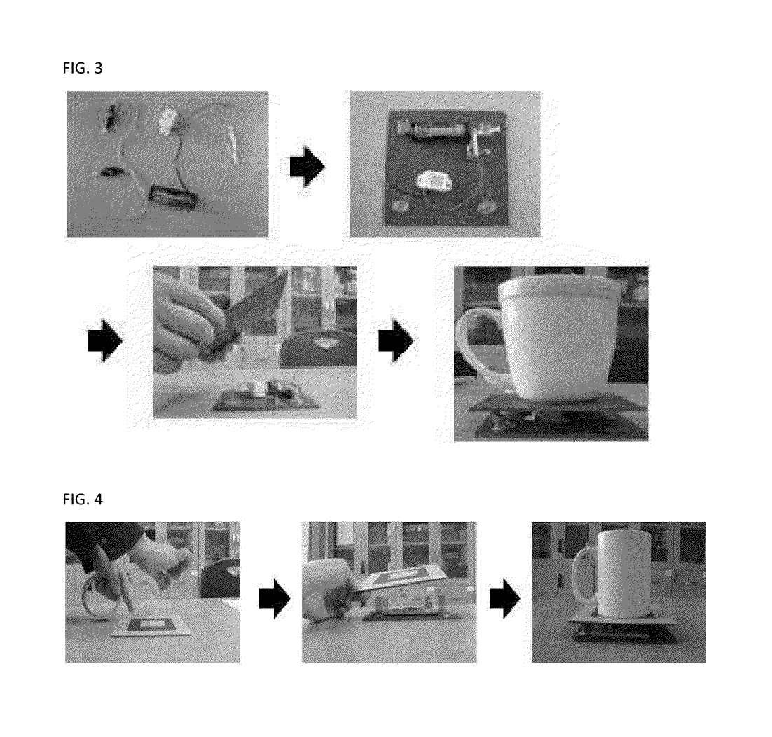

As illustrated in FIG. 3, four springs were disposed between a beverage coaster upper portion and a beverage coaster lower portion to then be fixed thereto using a glue gun and a buzzer was connected thereto as an audio unit, together with a piezoelectric element connected thereto. Here, as an amount of contents of a drinking vessel placed on the beverage coaster upper portion was increased while the drinking vessel was filled with water, the weight thereof was increased. The springs were then compressed by pressure thereon such that the beverage coaster upper portion and the beverage coaster lower portion contacted each other and a sound was generated by the buzzer, a weight detecting unit.

### Embodiment 2

A beverage coaster for a visually impaired person according to an exemplary embodiment of the present disclosure was manufactured through the same process as that of Embodiment 1, and additionally, a protrusion was further formed on an edge of the beverage coaster in order to improve frictional force between a drinking vessel and the beverage coaster as illustrated in FIG. 4.

According to an exemplary embodiment of the present disclosure, a beverage coaster for a visually impaired person is provided, which is capable of being easily and conveniently used by visually impaired persons everywhere. By using the beverage coaster according to an exemplary embodiment of the present disclosure, in the case that a beverage is poured into a drinking vessel to have a predetermined level of weight, a state of the drinking vessel into which the beverage is poured to have a predetermined level of weight may be identified by a user through a sound, so as to prevent the beverage from overflowing from the drinking vessel. In addition, the beverage coaster of the present disclosure may be prevented from slippage at an interface between the beverage coaster and the drinking vessel, whereby visually impaired persons may drink stably and conveniently.

While exemplary embodiments have been shown and described above, it will be apparent to those skilled in the art that modifications and variations could be made without departing from the spirit and scope of the present disclosure as defined by the appended claims.

What is claimed is:

1. A beverage coaster for a visually impaired person, comprising:
a beverage coaster upper portion;
a beverage coaster lower portion disposed to be spaced apart from the beverage coaster upper portion;
an elastic member disposed between the beverage coaster upper portion and the beverage coaster lower portion to form an interval therebetween;
a weight detecting unit detecting a weight of an object placed on the beverage coaster upper portion; and
an audio unit outputting a sound in the case that a predetermined level of weight is detected by the weight detecting unit.

2. The beverage coaster for a visually impaired person of claim 1, wherein the weight detecting unit is a load cell or a piezoelectric element.

3. The beverage coaster for a visually impaired person of claim 2, wherein in the case that the weight detecting unit is the load cell, the audio unit comprises a load cell initializing portion for zeroing the load cell.

4. The beverage coaster for a visually impaired person of claim 3, wherein the beverage coaster upper portion comprises an initialization button connected to the load cell initializing portion.

5. The beverage coaster for a visually impaired person of claim 1, wherein the sound is an alarm sound or a melody sound.

6. The beverage coaster for a visually impaired person of claim 1, wherein the elastic member is a spring.

7. The beverage coaster for a visually impaired person of claim 1, wherein a surface of the beverage coaster upper portion comprises an embossing or a concave-convex ( [symbol] ) portion.

8. The beverage coaster for a visually impaired person of claim 1, wherein a material of the beverage coaster upper portion contains one or more selected from a group consisting of nitrile rubber, natural rubber, acrylic rubber, urethane rubber, fluorinated rubber, silicon rubber, an epoxy-based resin, a polyimide resin, a polyamide resin, a phenol-based resin, and a melamine-based resin.

9. The beverage coaster for a visually impaired person of claim 3, wherein the weight detecting unit is set to detect a value of a weight selected from within a range of 150 g to 400 g.

10. The beverage coaster for a visually impaired person of claim 1, wherein the surface of the beverage coaster upper portion further comprises an edge protrusion having a height of 0.5 cm to 2 cm.

11. The beverage coaster for a visually impaired person of claim 1, further comprising a sealing portion sealing edges of the beverage coaster upper portion and the beverage coaster lower portion.
